(19) United States
(12) Patent Application Publication
(10) Pub. No.: US 2008/0086565 A1
(43) Pub. Date: Apr. 10, 2008

(54) VOICE MESSAGING FEATURE PROVIDED FOR IMMEDIATE ELECTRONIC COMMUNICATIONS

(75) Inventors: Thomas E Murphy, Hopewell Junction, NY (US); Jeffrey S. Stevens, Rochester, MN (US)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(73) Assignee: INTERNATIONAL BUSINESS MACHINES CORPORATION, Armonk, NY (US)

(21) Appl. No.: 11/539,920

(22) Filed: Oct. 10, 2006

(51) Int. Cl. G06F 15/16

(52) U.S. Cl. 709/227

(57) ABSTRACT

A system, method and program product for establishing instantaneous communication in a computer environment is provided. The method comprises: networking at least two nodes to one another such that they are in processing communication with one another, enabling a plurality of peers to use these nodes to establish peer to peer communication at any given time; and associating at least one sound file to each peer, and using it during peer to peer communication to identify the peers to one another. The sound files includes pre-recorded snippets that at least accurately identifies the associated peer.

### BACKGROUND OF THE INVENTION

1. Field of the Invention

This invention relates to a method, system and program product for sending electronic mail and more particularly for a method, system and program product for providing voice recognition features and using it in conjunction with instant messaging options.

2. Description of Background

In recent years, electronic communication has become a preferred medium of communication for many businesses and individuals. The preference stems from the many advantages that are provided by this mode of communication. Speed is becoming increasingly important in all communications. Electronic mail, also known as email or e-mail, is very advantageous in this regard, as it provides a near instantaneous form of communication in a very convenient manner. Besides urgency and convenience, e-mail also provides a recorded mode of communication which may be particularly beneficial in situations where a written record of the communication is needed for a variety of reasons such as to provide legal protection and for better information retention.

In recent years, sophisticated instant messaging facilities, have added options to allow messages to be sent using speech technology. This new development combines the benefits previously only afforded by telephone with the advantages offered by traditional e-mail communication, as stated. In some instances, the facilities provided allow the senders name, message or both to be provided using text to speech (TTS) technology. The same facilities can also be used in conjunction with traditional e-mail such that both the senders name and subject description for e-mail that is received can also be spoken in addition to instant messages.

Unfortunately, while in theory TTS, and other similar technology, offer many advantages, in practice the words spoken such as by TTS facilities need much improvement. Often the pronunciation of the words is incorrect or inaccurate, leading to misleading or incorrect information. In addition since the same digital or computerized voice input is used, virtually all announcements and associated text output sounds quite similar. This takes away from some of the intended benefits such as alerting the user to a particular message or from a particular person.

Consequently, it is desirable to provide voice messaging options, that can be used both with instant messaging and e-mail communication, which are error free and distinguishable in the information they provide.

### SUMMARY OF THE INVENTION

The shortcomings of the prior art are overcome and additional advantages are provided through a system, method and program product for establishing instantaneous communication in a computer environment. The method comprises: networking at least two nodes to one another such that they are in processing communication with one another, enabling a plurality of peers to use these nodes to establish peer to peer communication at any given time; and associating at least one sound file to each peer, and using it during peer to peer communication to identify the peers to one another. The sound files includes pre-recorded snippets that at least accurately identifies the associated peer.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is an illustration of a computer system environment having a plurality of nodes as used in conjunction with one embodiment of the present invention; and

FIG. 2 is a flow chart illustration of a process flow as per one of the embodiments of the present invention.

### DESCRIPTION OF THE INVENTION

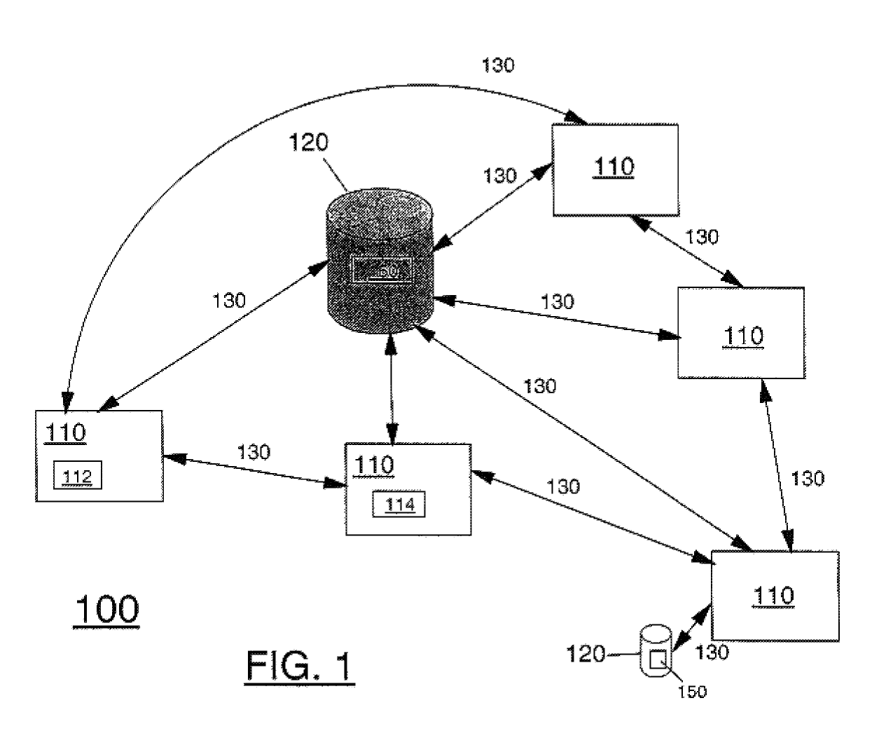

FIG. 1 provides an example of a computing environment 100 having a plurality of nodes 110 and resources 120 in processing communication with one another using a network referenced as 130. resources can also vary as known to those skilled in the art. In this example, resources are shown to include storage units. Nodes 110 can comprise a range of computing devices including personal computers. The network can also comprise of a variety of arrangements including the internet and internal networks as may be supported privately by a certain entity or corporation. Each node 110 can send and receive messages to and from other nodes and resources as provided in environment 100.

In this embodiment, the nodes 110 support operating systems and applications enabled to provide instant messaging within the network. These and other enabling software and hardware supported by the environment 100 will be collectively referenced as the environment facilities. One such facility as supported by the environment 100 is instant messaging function and/or applications.

Instant messaging can be defined as a form of real-time or instantaneous form of written communication between two or more entities. The text message is conveyed via nodes 110 using the network 130. Some instant messaging applications may require the use of one or more client programs that interface to an instant messaging service. Communications are then achievable instantaneously and in real-time between peers via these nodes. Users can establish a list of contacts consisting of their peers. Any peer seeking to initiate or respond to a communication, can use nodes or other environment's facility, to check availability of other peers at any given time, and subsequently if available start communicating with them. This concept is shown in the illustration of FIG. 1.

As illustrated in FIG. 1, a plurality of peers 112 and 114 are shown using nodes 110. In this example peer 112 has initiated communication with peer 114. For ease of reference peer 112, will be referenced as the initiating peer and peer 114 as receiving or responding peer, as appropriate. It should be noted that a plurality of peers can initiate and/or be in communication with each other or other peers at any given time.

Instant messaging facilities used by the present invention can be varied as known to those skilled in the art. Any instant messaging facility that boosts communication and allows easy collaboration can be easily implemented in the present invention. It may be preferred to use instant messaging facilities that easily allow the parties to know whether the peer is available, busy, or away from the computer.

In one embodiment, for example as the one discussed in conjunction with FIG. 1, the environment 100 supports speech technology and related facilities. In this embodiment, the instant messaging supported by the nodes 110 also comprises at least one and often a plurality of sound files and even more sophisticated sound facilities, that may be comprised of files and/or other application components. The sound files and/or facilities, (hereinafter referenced as sound files for ease of understanding and reference), in one embodiment, are provided to voice-enabled applications in the environment 100 to support proper recognition and pronunciation of words and take advantage of the bandwidth and storage capacity of the environment. As will be also discussed later, the sound files correlate to peers and can be stored locally on a node or in a central repository or both. In the example of FIG. 1, the sound files are generally shown and referenced as 150. It should be noted that sound files can be utilized in both initiating and responding in peer to peer communication.

Incorporating a sound file provides many advantages when used in conjunction with speech technology. The sound file, combines the benefits afforded by e-mail with the advantages provided by a telephone without being as intrusive as a telephone. For example, using an instant messaging facility allows the users the opportunity to wait before responding. In such cases, the users are not to be forced to reply immediately to incoming messages. In addition, when recording is desired, instant message facilities that allow transcript logging can be used. In such cases instant messages can be logged in a local message history, and recorded to allow advantages provided by traditional e-mail. In the embodiment provided a sound file will also be used and provided by the instant messaging facilities.

Incorporating a sound file also provides additional advantages. Such advantages can range from providing assistance to the disabled to providing convenience of checking e-mail when a display can not be used such as while driving. Spoken words can also alert an otherwise inattentive recipient to the incoming instant message or even e-mail.

These sound files provided in on embodiment of the present invention, include pre-recorded snippets that readily identify peers, in their native voice (i.e. own voice when human voice) as per one embodiment, among other things and can be referenced as peer/“buddy” pre-recorded snippets and/or messages. It should be understood that any information can be included in these snippets, and more than one sound file (and thus more than one snippet) can be correlated and associated with each peer. This pre-recorded information, for example, can contain the actual voice recording of the owner or generator of the message. This is particularly advantageous when the digital pronunciation or recognition of words may lead to inaccuracies. In a preferred embodiment, personally recorded sound file snippets are provided to voice-enabled applications by taking advantage of the bandwidth and storage capabilities of the network. The snippets can also be used to pronounce names and words properly, with added benefit of being in the actual voice of the sender. Such pre-recorded snippets could also include, other standard features such as “announcements” for voice-enabled applications. For example, these “announcements” may include (but should not be limited to) instant message utilities using such pre-recorded common phrases as:

Text message From:”;
“Email received From:”.

Alternatively, the sender can also prerecord “their own selective” or “their own distinctive” phrases for each such common announcement. The sound files including these phrases can also be arranged/rearranged at any given time to form (new) announcements by sequence of phrases included in the snippets. They will then be subsequently used in peer to peer communications. In other words, if more than one sound file is associated to each peer, these sound files can be arranged in a certain pre-selected sequence when desired.

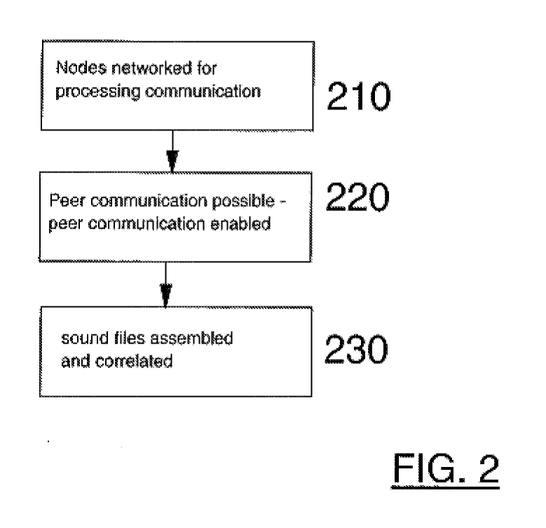

FIG. 2 provides a flowchart illustration of the above mentioned process. Once the nodes and other resources in the environment are in processing communication, as referenced at 210, and the peer communication can be ensured (referenced by block 220, the sound files are identified and correlated to the appropriate peers and sent to provide more information about each peer (block 230).

For ease of understanding, a particular example will now be discussed as how such files can be used by the environment 100 and nodes 110. It should be understood, however, that although the example as will be discussed below provides for one embodiment of the present invention, it is only used to enhance understanding and therefore this embodiment should not be considered to limit the workings of the present invention as other alternative embodiments are available and can be implemented.

In one embodiment, the embodiment 100 supports speech technology and voice-enabled applications, such as Notesbuddy, via such networking services such as internet (i.e Web Services). Notesbuddy is often used in conjunction with International Business Machines (IBM) Corporation's Lotus Notes™ internet mail and Lotus Sametime™ which provides instant messaging. Notesbuddy has the capacity to provide voice, pager and display facilities which is why it is being used here as an example to ease understanding. Other examples and facilities other than Notesbuddy can easily be used/substituted in conjunction with the workings of the present invention. For ease of understanding, however, the discussion below incorporates the use of Notesbuddy.

One advantage of Notesbuddy is that it can monitor e-mail at the server or the replica. The filter-setting page allows definition of important email according to simple criteria such as names or keywords. NotesBuddy works well with Lotus Notes and Domino, so it shares the inbox, the folders, and address books. Audio notes allow for composition of and listening to email using recorded voice attachments. NotesBuddy is “multimodal,” so it can play back either text or audio mail using the same user interface. This can be used in conjunction with the workings of the present invention to allow user(s) a great variety of options and application selection.

In one example, when Notesbuddy and Sametime are both used (Lotus Sametime Connect is installed), NotesBuddy can access the Sametime server and provide instant messaging and buddy status. NotesBuddy shows buddy status in email headers and in the inbox view, as well as in a buddy list. Chats or email can be initiated any place a buddy name is displayed and then saved to folders or forwarded to others. Rich text and graphics (such as smiley faces and Web graphics) can also be exchanged when chatting with other NotesBuddy users.

In this way, Notesbuddy can be used to access and use a sound file. When Notesbuddy is not used, a sound file can still be made available. In either case, it is preferred to use the actual users voice. A variety of standards, can be used for the format of the sound file. In one embodiment, the sound file can be a WAV (or Wave) or MPEG-1 Audio Layer 3 (MP3) file as supported by the environment. (MP3, is a popular digital audio specific compression encoding format, designed to greatly reduce the amount of data required to represent audio, while maintaining the sound quality. WAV is short for Waveform audio format which is another standard for storing audio on PCs. It is a variant of the RIFF bit-stream format method for storing data in chunks.)

For ease of understanding the following scenario will now be provided and discussed as per one embodiment of the present invention. Assume a situation where a first user X (hereinafter also referenced as User 1), sends an instant message to a second user (User 2) Y. X and Y are using respective nodes. When the message is received by Y, Notesbuddy uses Web Services to locate and download the associated pre-recorded user X greeting WAV file from a repository that is preferably used by the network, or alternatively by X. This WAV file is then cached locally, such as on user Y's system, desk etc., with X's other buddy information. Anytime messages from X arrive, Notesbuddy will use the WAV file to announce X's name, using X's voice.

It should be noted that this method is different and advantageous to the real-time connections provided by TCP/IP and other network connections for the purposes of establishing real time chats or connection between two clients for voice communication purposes that are instantaneous. One advantage provided by the present invention is that no dedicated real time connection is needed as the user is not actually in instant voice communication with other users/clients. Therefore, no channel is used for piping data to and from the microphones/speakers of one or both clients. This is because no person is actually speaking live into a microphone in order to voice the words or messages.

Another advantage of the present invention is also that it can actually be adaptable and used to extend the text-to-speech (TTS) features that may be supported by many software applications for instant messaging clients. These features are usually pre-packaged voices for TTS engines that can be built-in to the messaging clients. In this way one can select attributes, such as accents, languages and the make gender (male or female) selection for greeters voice. The present invention does not replace these features, but is used in conjunction with them to extend their capability even further when such features are supported.

While the conventional messaging methods are abstractions of voice over IP (VOIP) technology, which largely addresses the steady-state dialogue and not the pre-connection announcement phase, the present invention can be used to provide and improve the ability to recognize the incoming communications from a particular source or user for the purpose of screening or recognizing urgency.

In a preferred embodiment of the present invention, a template of words, comprising in some instances of one that encompasses more than 500 words, can be selected to create other WAV, MPS or similar sound files. In this embodiment, these common words can be spoken by someone selectively (such as the user of a particular node), so that it can be later used to say words or whole messages in the sender's natural voice.

Such enhanced messages, are then instantly recognizable by the receiver who is familiar and recognizes the sender's voice. Such recognition can help prioritize the urgency of the message (one's supervisor, spouse or other family member) without ever having to interrupt the work flow of the user of the receiving node. In alternate embodiments, important users, such as one's boss or spouse can be pre-selected to speak the incoming message while the user continues to work on other tasks on the node or sits by the node while busy with other work.

In other embodiments, the concept of the present invention as discussed above can be also extended to provide a variety of other benefits. In one example, the receiving node, can be comprised of software that helps the handicapped. In one example, a blind user, can use the invention to recognize and even remember speakers that they are unable to see using Icons.

In an alternate embodiment, the invention can be applied to foreign language recognitions. In this embodiment, the Web services are enabled such that they download sound files such as WAV files, of the speaker's voice in the listeners language for these foreign language speakers, therein yielding a dynamic translation.

Many other advantages and application can also be possible using the present invention. The invention can be made available as a web service and be accessible via a variety of common networking and internet protocols such as HTTP. The ability to download the sound files locally is selective and is used for faster-reuse (such as cached locally on a personal computer). However, in alternate embodiments, these can be stored on a network or other resources that may be available on the system to enable more than one receiving user to be able to use or access them from a repository (such as a directory used by a large corporation or a small firm). In either case, the ability to recognize speakers and to selectively screen the users and/or messages without having to read the screen or listen to the entire message remains in the control of the recipient.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method of establishing instantaneous communication in a computer environment, comprising:
networking at least two nodes to one another such that they are in processing communication with one another;
enabling a plurality of peers to use said nodes of said networked environment to establish peer to peer communication at any given time;
associating at least one sound file to each peer, and using said file during peer to peer communication to identify said peers to one another; and
said sound files including pre-recorded snippets such that at least identify said initiating peer.

2. The method of claim 1, wherein said pre-recorded snippets are in said peer's native voice to inherently and accurately identify said initiating peer.

3. The method of claim 2, further comprising providing sound files to voice enables applications residing in said networked environment using bandwidth and storage capabilities of said environment to enhance communication between peers.

4. The method of claim 2, wherein availability of any peer can be checked by other peers at any given time when trying to establish peer to peer communications.

5. The method of claim 2, wherein there are a plurality of sound files and other related services, thus creating one or more sound facilities.

6. The method of claim 2, wherein said sound file(s) are stored in a central repository in said environment.

7. The method of claim 6, wherein said sound files(s) can be accessed at any time by any peer.

8. The method of claim 7, wherein said pre-recorded snippets include other pre-recorded phrases not relating to peer identifying information.

9. The method of claim 8, wherein more than one sound file can be associated to each peer.

10. The method of claim 9, wherein said sound files can be dynamically arranged and played in a particular sequence that is pre-selected.

11. The method of claim 10, wherein said sound files when arranged in a certain sequence form an announcement used in peer to peer communication.

12. The method of claim 6, further comprising:
once a message is received from an initiating peer, searching said central repository for said environment via said network to locate information about said initiating peer in form of sound files.

13. The method of claim 12, wherein said information about each individual initiating peer once retrieved from said repository can then be stored locally on a node used by said receiving peer for later use.

14. The method of claim 1, wherein said sound file(s) relating to said peer(s) are stored locally at node(s) used by said initiating peer.

15. The method of claim 1, wherein a variety of filters are available in said environment to prioritize communication received by a receiving peer from different initiating peers according to a variety of pre-selected criteria including said sound files.

16. The method of claim 1, wherein said sound files are in MP3 format.

17. The method of claim 1, wherein said sound files are in WAV format.

18. The method of claim 1, wherein a template of words can be arranged and associated to each peer in form of a plurality of sound files and these sound files can then be arranged and rearranged to form phrases as desired and used during peer to peer communications.

19. A system for establishing instantaneous communication in a computer environment, comprising:
a plurality of nodes networked together such that they are in processing communication with one another;
said nodes being used by one or more peers such that said peers can use said networked nodes to establish communication between themselves at any given time;
at least one sound file correlating to each peer and stored in said environment such that when establishing communication between said peers, said sound files can be retrieved by said node(s) and used in establishing peer to peer communications;
said sound file including pre-recorded snippets having at least information that accurately identifies each peer.

20. A program product comprising:
a program configured to perform a method of establishing instantaneous communication in a computer environment having a plurality of networked nodes, the method comprising:
(a) networking at least two nodes to one another such that they are in processing communication with one another;
(b) enabling a plurality of peers to use said nodes of said networked environment to establish peer to peer communication at any given time;
(c) associating at least one sound file to each peer, and using said file during peer to peer communication to identify said peers to one another; and
(d) said sound files including pre-recorded snippets that at least accurately identifies said associated peer.
